(19) United States
(12) Patent Application Publication
(10) Pub. No.: US 2005/0239517 A1
(43) Pub. Date: Oct. 27, 2005

(54) Cordless telephone handset

(76) Inventors: Minoru Ogino, Tokyo (JP); Hitoshi Hachiga, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/983,317

(22) Filed: Nov. 5, 2004

(30) Foreign Application Priority Data
Apr. 26, 2004 (JP) 2004-130122

(51) Int. Cl. H04B 1/44; H04M 1/00; H04B 1/38

(52) U.S. Cl. 455/573; 455/556.1

(57) ABSTRACT

A cordless telephone system including a cordless telephone handset arranged to store or wirelessly transmit a captured image without having a large capacity of secondary battery built-in. The cordless telephone handset includes an imaging section, a secondary battery, a wireless section for transmission of images captured by the imaging section, a storage section for storing images captured by the imaging section, and a power supply circuit that supplies (i) secondary battery power to the imaging section, wireless section, and storage section, and (ii) power required for recording or wireless-transmission of the captured image, to the imaging section, wireless section, and storage section during the time when the secondary battery is charged by a battery charger.

### BACKGROUND OF THE INVENTION

1. Field of the Invention

The present invention relates to a cordless telephone handset having fixed-point observation features therein, and more particularly to an improvement technology for carrying out storing or wireless-transmission of a captured image, without having a large capacity of secondary battery built-in.

2. Description of the Related Art

Japanese Published Unexamined Patent Application No. 2004-112444 discloses a cordless telephone, in which an image captured by a cordless handset equipped with a camera is wireless-transmitted to a base phone, and then the base phone that has received the captured image displays it on a display section. This cordless telephone enables to increase its convenience, because the camera built-in cordless handset can be set in any place and an image of the setting site can be viewed using the display section of the base phone as a monitor screen.

However, there has been a problem that the capacity of the secondary battery incorporated in the cordless handset is too small, because a considerable amount of electric power is consumed for storing an image captured by the camera in a built-in memory or for wireless-transmission of the image to the base phone.

### SUMMARY OF THE INVENTION

The present invention relates in one aspect to a cordless telephone handset that can carry out storing or wireless-transmission of a captured image without having a large capacity of secondary battery built-in.

The invention in another aspect provides a battery charger suitable for fixed-point observation.

The present invention in one aspect relates to a cordless telephone handset that includes: an imaging section which captures an image; a secondary battery which accumulates electric power; a wireless section which wireless-transmits an image that has been captured by the imaging section; a storage section which stores the image that has been captured by the imaging section; and a power supply circuit which supplies the electric power accumulated in the secondary battery to the imaging section, wireless section, and storage section, wherein the power supply circuit supplies the electric power, which is required for recording or wireless-transmission of the captured image, to the imaging section, the wireless section, and the storage section when the secondary battery is charged by a battery charger. By supplying the electric power required for recording or wireless-transmission of the captured image to the imaging section, the wireless section, and the storage section during charging of the secondary battery, it is possible to store or wireless-transmit the captured image without incorporating a large capacity of secondary battery into the cordless telephone handset.

In a further aspect, the invention relates to a battery charger for charging the secondary battery incorporated in the cordless telephone handset, and is provided with a moving section which performs position control of the cordless telephone handset in order to adjust the imaging direction of the imaging section. Adjustment of the imaging direction is possible by controlling a position of the cordless telephone handset placed on the battery charger.

In yet another aspect, the invention relates to a cordless telephone system, including
(A) at least one cordless telephone handset, each cordless telephone handset comprising:
   an imaging section which captures an image;
   a secondary battery which accumulates electric power;
   a wireless section which wireless-transmits an image that has been captured by the imaging section;
   a storage section which stores the image that has been captured by the imaging section; and
   a power supply circuit which supplies the electric power accumulated in the secondary battery to the imaging section, wireless section, and storage section,
   wherein the power supply circuit supplies the electric power, which is required for recording or wireless-transmission of the captured image, to the imaging section, the wireless section, and the storage section when the secondary battery is charged by a battery charger; and
(B) a base telephone arranged in wireless-transmission-receiving relationship to the at least one cordless telephone handset to receive the captured image from the at least one cordless telephone handset and to display same.

Other aspects, features and embodiments of the invention will be more fully apparent from the ensuing disclosure and appended claims.

### BRIEF DESCRIPTION OF THE DRAWINGS

FIG. 1 is a block diagram of a cordless telephone according to one embodiment of the invention.

FIG. 2 (FIGS. 2A-2E) is a set of drawings in explanation of a situation in which an imaging direction of the cordless handset is adjusted.

### DESCRIPTION OF THE PREFERRED EMBODIMENTS

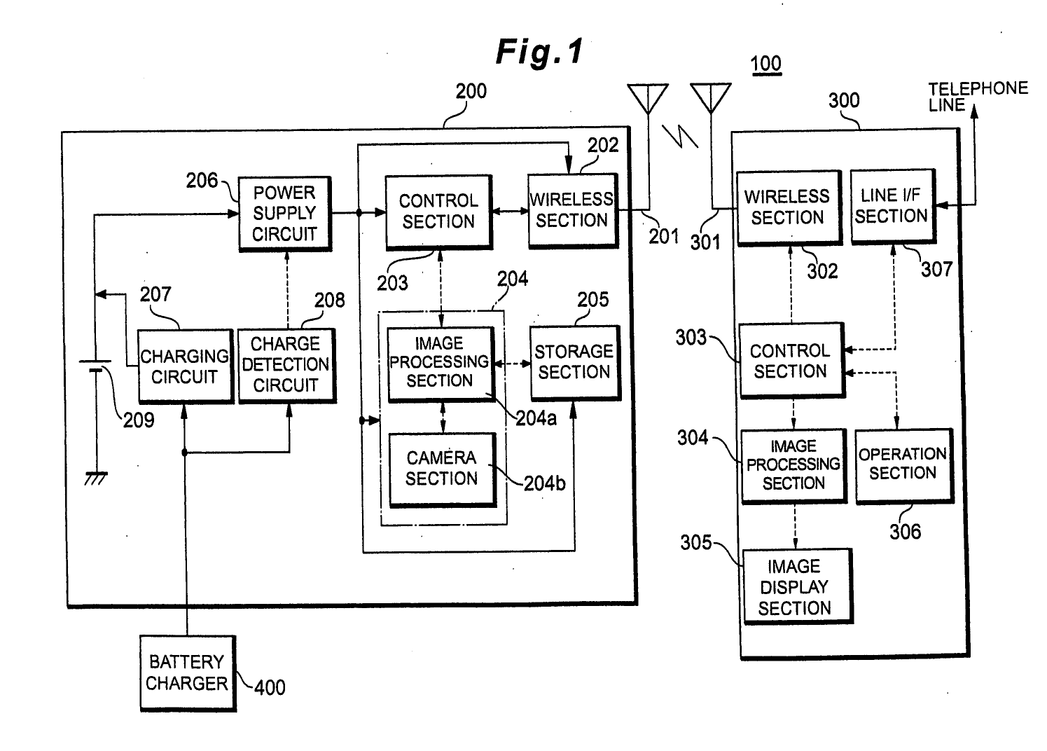

FIG. 1 is a block diagram of a cordless telephone of the present invention in one embodiment thereof. The cordless telephone 100 includes a cordless handset 200 and a base phone 300. In the figure, a solid line indicates an electric power supply line, while a dashed line indicates a control signal line. For the sake of explanatory convenience, the figure shows mainly a processing system for a captured image, and a processing system for an audio signal required for audio communication is omitted. The cordless handset 200 includes an imaging section 204 which captures an image, a storage section 205 which stores a captured image, a wireless section 202 which wire-transmits the captured image to the base phone 300, an antenna 201 which sends and receives a radio signal, a secondary battery 209 in which electric power is accumulated, a charging circuit 207 which charges the secondary battery 209 with electric power supplied from a battery charger (external power supply) 400, a charge detection circuit 208 which detects an electric connection between the charging circuit 207 and the battery charger 400, a power supply circuit 206 which distributes the electric power accumulated in the secondary battery 209 to each of the sections, and a control section 203 which controls the entire cordless handset 200.

For the sake of explanatory convenience, although there is one unit of the cordless handset 200, the cordless telephone 100 may be configured such that a plurality of the cordless handsets 200 are set and a captured image is wireless-transmitted from each of the cordless handsets 200 to the base phone 300.

By placing the cordless handset 200 on a mount and the like of the battery charger 400, the charging circuit 207 and the battery charger 400 are electrically connected, whereby the secondary battery 209 is charged. The charge detection circuit 208 detects an electric connection between the charging circuit 207 and the battery charger 400 by detecting the voltage and the like between the terminals of the charging circuit 207. When uncharging (during a call, for example), although the power supply circuit 206 supplies the electric power required in audio communication and the like to the wireless section 202 and control section 203, the power supply circuit 206 halts the electric power supply to the imaging section 204 which requires a considerable amount of electric power, and deactivates the imaging function. When charging, on the other hand, the power supply circuit 206 performs the supply of the electric power to not only the wireless section 202 and control section 203 but also the imaging section 204 and storage section 205, and secures the electric power required for imaging (the electric power required for either recording or wireless-transmission of the captured image, or the electric power required for both recording and wireless-transmission of the captured image). The imaging section 204 is constituted as including a camera section 204a constituted by a solid-state image sensing device such as CCD (Charge Coupled Device) or an optical lens and the like, and an image processing section 204b which performs image processing of a captured image (zooming processing, image compression processing and so on). A captured image which has been imaged by the imaging section 204 is sent to the wireless section 202 and wireless-transmitted to the base phone 300, or is subjected to a process of image compression and the like in the image processing section 204b and accumulated (recorded) in the storage section 205.

On the other hand, the base phone 300 is constituted as including an antenna 301 which sends and receives a radio signal, a wireless section 302 which receives a captured image which has been wireless-transmitted from the cordless handset 200, an image processing section 304 which performs image processing of the received captured image, an image display section 305 which displays the captured image, an operation section 306 in which a user performs key input, a line interface section 307 which is connected to the telephone line, and a control section 303 which controls the entire base phone 300.

In the above configuration, when charging of the battery is started by placing the cordless handset 200 on the battery charger 400, the cordless handset 200 starts imaging automatically and performs wireless-transmission of the captured image to the base phone 300 or performs recording of same in the storage section 205. Fixed-point observation is possible by the cordless handset 200 by performing imaging on the battery charger 400. Further, when the charging of the cordless handset 200 is cancelled, imaging is stopped, and wireless-transmission of the captured image to the base phone 300 and recording of same in the storage section 205 are also halted. The cordless telephone may be constructed and arranged so that imaging is constantly performed during the time when the cordless handset 200 is placed on the battery charger 400, or alternatively so that imaging is performed intermittently at regular time intervals. As a still further variation, the cordless telephone may be constructed and arranged so that transmission and recording of the image are switched according to the instructions from the base phone 300 during the time when the cordless handset 200 is placed on the battery charger 400, to perform the following action:

(1) There is a situation in which the cordless handset 200 is in a call or in which wireless-transmission of a captured image cannot be performed because of an incoming call or a transmission request from the other cordless handset during wireless-transmission of the captured image, and so on. In such situation, the captured image may be recorded in the storage section 205 so that wireless-transmission is performed when possible.

(2) The cordless handset 200 performs recording constantly according to the instructions from the base phone 300 and accumulates the captured image in the storage section 205. This captured image is wireless-transmitted to the base phone 300, when necessary, according to a request from the base phone 300. Instruction from the base phone 300 to the cordless handset 200 may be carried out by an input operation to the operation section 306, and may be carried out via an outside line or a personal computer.

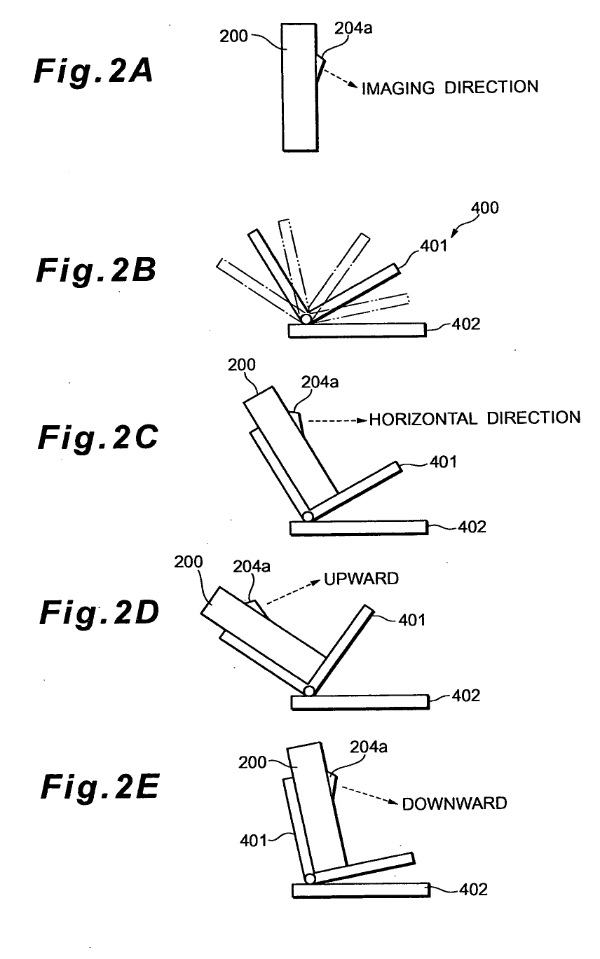

FIG. 2 (FIGS. 2A-2E) is a set of drawings in explanation of a situation in which an imaging direction of the cordless handset 200 is adjusted. As shown in FIG. 2A, the camera section 204a of the cordless handset 200 is attached so as to image an image substantially downward with respect to a horizontal direction. As shown in FIG. 2B, the battery charger 400 is provided with a moving section 401 which performs position control of the cordless handset 200 in order to adjust the imaging direction of the imaging section 204, and a fixed section 402. The moving section 401 is a charging base on which the cordless handset 200 is placed and is configured to be tiltable with respect to the fixed section 402 by means of a hinge mechanism. Here, a solid line indicates a normal position of the moving section 401, a dashed line with single dots is a position in which the moving section 401 is rotated backward from the normal position, and a dashed line with double dots indicates a position in which the moving section 401 is rotated forward from the normal position. As shown in FIG. 2C, if the moving section 401 is set to the normal position and the cordless handset 200 is placed on the moving section 401, the position of the cordless handset 200 is controlled so the camera section 204a faces the horizontal direction. If fixed-point observation is performed in this position, it is possible to observe from the battery charger 400 the range that can be viewed in the horizontal direction.

As shown in FIG. 2D, if the moving section 401 is set to the position where it is rotated backward from the normal position, and the cordless handset 200 is placed on the moving section 401, the position of the cordless handset 200 is controlled so the camera section 204a faces upward from the horizontal direction. If a fixed-point observation is performed in this position, it is possible to observe the range that can be viewed upward from the horizontal direction. As shown in FIG. 2E, if the moving section 401 is set to the position where it is rotated forward from the normal position, and the cordless handset 200 is placed on the moving section 401, the position of the cordless handset 200 is controlled so the camera section 204a faces downward from the horizontal direction. If fixed-point observation is performed in this position, it is possible to observe the range that can be viewed downward from the horizontal direction.

Further, the position of the moving section 401 is not necessarily fixed during imaging, and may be configured such that it can be changed automatically based on the instructions of the base phone 300 and the like. Moreover, a rotation mechanism and the like may be further added to the moving section 401 so that the imaging direction can be adjusted in not only the vertical direction but also a horizontal direction. The camera section 204a may be configured movably with respect to the main body of the cordless handset 200, thereby freely changing the imaging direction according to the instructions of the base phone 300 and the like.

In this illustrative embodiment, since the electric power required for imaging can be obtained from the battery charger 400, it is not necessary to increase the capacity of the secondary battery 209 incorporated in the cordless handset 200. Therefore a small capacity of the secondary battery 209 is sufficient. Further, by recording the captured image in the cordless handset 200, it is possible to perform fixed-point observation without forming a wireless connection between the base phone 300 and the cordless handset 200 and to confirm in the base phone 300 the image recorded in accordance with the instructions from the base phone 300. Furthermore, by setting a plurality of the cordless handsets 200 as security cameras and by analyzing the image captured by the plurality of the cordless handsets 200 by means of a suitable software, it is possible to find trespassers and the like and to inform about abnormal happenings.

While the invention has been disclosed herein with reference to illustrative aspects, features and embodiments, it will be appreciated that the invention is not thus limited, and that other variations, modifications and alternative embodiments will suggest themselves to those of ordinary skill in the art, based on the disclosure herein. Accordingly, the claims hereafter set forth are intended to encompass all such variations, modifications and alternative embodiments, as being within the spirit and scope of the invention.

1. A cordless telephone handset, comprising:
an imaging section which captures an image;
a secondary battery which accumulates electric power;
a wireless section which wireless-transmits an image that has been captured by said imaging section;
a storage section which stores the image that has been captured by said imaging section; and
a power supply circuit which supplies the electric power accumulated in the secondary battery to said imaging section, wireless section, and storage section,
wherein said power supply circuit supplies the electric power, which is required for recording or wireless-transmission of the captured image, to said imaging section, said wireless section, and said storage section when said secondary battery is charged by a battery charger.

2. A battery charger for charging the secondary battery incorporated in the cordless telephone handset of claim 1, the battery charger being provided with a moving section which performs position control of said cordless telephone handset in order to adjust the imaging direction of said imaging section.

3. A cordless telephone system, including
(A) at least one cordless telephone handset, each cordless telephone handset comprising:
an imaging section which captures an image;
a secondary battery which accumulates electric power;
a wireless section which wireless-transmits an image that has been captured by said imaging section;
a storage section which stores the image that has been captured by said imaging section; and
a power supply circuit which supplies the electric power accumulated in the secondary battery to said imaging section, wireless section, and storage section,
wherein said power supply circuit supplies the electric power, which is required for recording or wireless-transmission of the captured image, to said imaging section, said wireless section, and said storage section when said secondary battery is charged by a battery charger; and
(B) a base telephone arranged in wireless-transmission-receiving relationship to said at least one cordless telephone handset to receive the captured image from said at least one cordless telephone handset and to display same.

4. The cordless telephone system of claim 3, wherein the base telephone comprises:
a radio signal antenna for transmitting and receiving radio signals;
a wireless section which receives the captured image wireless-transmitted from said at least one cordless telephone handset;
an image processing section which performs image processing of the received captured image;
an image display section which displays the captured image;
an operation section in which a user performs key input;
a line interface section connectable to a telephone line; and
a control section.

5. The cordless telephone system of claim 3, wherein the captured image is wireless-transmitted from said at least one cordless telephone handset during cordless telephone handset charging.

6. The cordless telephone system of claim 3, wherein the captured image is intermittently wireless-transmitted from said at least one cordless telephone handset at a predetermined regular time interval.

7. The cordless telephone system of claim 3, further comprising a battery charger for cordless telephone handset charging, wherein the battery charger includes a moving section which performs position control of the cordless telephone handset in order to adjust the imaging direction of said imaging section of the cordless telephone handset.
